(19) United States
(12) Patent Application Publication
(10) Pub. No.: US 2025/0004112 A1
(43) Pub. Date: Jan. 2, 2025

(54) DETECTION METHOD, APPARATUS, AND ELECTRONIC DEVICE

(71) Applicant: SUTENG INNOVATION TECHNOLOGY CO., LTD., Shenzhen (CN)

(72) Inventor: Kaipeng ZHANG, Shenzhen (CN)

(73) Assignee: SUTENG INNOVATION TECHNOLOGY CO., LTD., Shenzhen (CN)

(21) Appl. No.: 18/666,778

(22) Filed: May 16, 2024

(30) Foreign Application Priority Data
Jun. 27, 2023 (CN) 202310769146.1

(51) Int. Cl. G01S 7/487; G01S 17/89

(52) U.S. Cl. CPC G01S 7/487; G01S 17/89

(57) ABSTRACT

The present disclosure provides a detection method, apparatus, and electronic device, relating to the field of LiDAR technology. The method includes: obtaining ambient information; determining a first signal processing mode for a receiver to process a current scanning received detection echo based on the ambient information; processing a received echo signal based on the first signal processing mode; and generating detection information based on the processed received echo signal.

### CROSS-REFERENCE TO RELATED APPLICATION

The present application claims the benefit of priority to Chinese Patent Application No. 202310769146.1, filed on Jun. 27, 2023, which is hereby incorporated by reference in its entirety.

### TECHNICAL FIELD

The present disclosure relates to the field of LiDAR technology, particularly to a detection method, apparatus, electronic device, and storage medium.

### TECHNICAL BACKGROUND

Autonomous driving requires various sensors to detect obstacles and the surrounding environment. Vehicles equipped with these sensors have different roles and performance based on the distance, angle, and detection accuracy of the target being tested. In particular, to achieve high-precision advanced visual functions in practical applications of autonomous driving, multiple types of sensors must be used for so-called “sensor fusion” to compensate for the deficiencies of each sensor.

As the requirements for detection accuracy in autonomous driving are increasing, data output based on a single sensor may be limited by resolution and may not meet the detection needs of autonomous driving.

### SUMMARY

Embodiments of the present disclosure is to provide a detection method, device, electronic equipment, and storage medium that can solve the issue of determining different processing modes for detection echoes based on environmental information to further enhance detection resolution.

According to one aspect of the present disclosure, a detection method is provided, including: obtaining ambient information; determining a first signal processing mode for a receiver to process a current scanning received detection echo based on the ambient information; processing a received echo signal based on the first signal processing mode; and generating detection information based on a processed received echo signal.

In an embodiment, the method further includes: obtaining a sampling frequency of a detection echo signal processing mode and a sampling number of a detection echo; and determining a second signal processing mode for the detection echo based on the sampling frequency of the detection echo signal processing mode and the sampling number of the detection echo.

In an embodiment, the ambient information includes ambient light information, and accordingly, determining the first signal processing mode for the receiver to process the current received detection echo based on the ambient information includes: determining the first signal processing mode for the receiver to process the current received detection echo based on the ambient light information.

In an embodiment, the first signal processing mode is a gray image output mode or a point cloud signal processing output mode.

In an embodiment, the second signal processing mode is a gray image output mode or a point cloud signal processing output mode.

In an embodiment, determining the first signal processing mode for the receiver to process the current received detection echo based on the ambient light information includes:
determining that the receiver performs detection echo output in the gray image output mode when the value of ambient light intensity information is greater than a first preset value; and
determining that the receiver performs detection echo output in the point cloud signal processing mode when the value of the ambient light intensity information is less than or equal to the first preset value.

In an embodiment, the method further includes: obtaining a minimum receiving unit corresponding to the first signal processing mode; and performing output of the detection information based on the minimum receiving unit.

In an embodiment, the method further includes: obtaining a correspondence between an output frequency of the detection information and a scanning number; and performing output of the detection information when a first preset scanning number corresponds to one output of the detection information, fusing the detection information obtained based on the first preset scanning number based on a preset rule.

In an embodiment, one scanning includes a plurality of signal emission angles, and the point cloud signal processing mode includes: superimposing echo signals of each emission angle in the plurality of signal emission angles; and obtaining a superimposed echo signal.

According to another aspect of the present disclosure, a detection apparatus is provided, including: an ambient information obtaining module, configured to obtain ambient information; a determining module, configured to determine, based on the ambient information, a first signal processing mode for a receiver to process a current scanning received detection echo; a processing module, configured to process a received echo signal based on the first signal processing mode; a generating module, configured to generate detection information based on a processed received echo signal.

According to a third aspect of the present disclosure, an electronic device is provided, including a memory, a processor, and a computer program stored in the memory and executable on the processor, wherein the processor implements the detection method according to any one of the claims in the present disclosure.

According to a fourth aspect of the present disclosure, a computer-readable storage medium is provided, on which a computer program is stored, wherein a processor implements the detection method according to any one of the claims in the present disclosure when executing the computer program.

By obtaining environmental information, the present disclosure determines a first signal processing mode for a receiver to process a current scanning received detection echo based on the environmental information, processes a received echo signal based on the first signal processing mode, and generates detection information based on the processed received echo signal. The present disclosure determines the first signal processing mode for the detection echo based on the environmental information by switching the processing mode of the detection echo signal under the same receiving lens and receiver, where the first signal processing mode includes a gray image output mode or a point cloud signal processing output mode. When the environment meets the requirements, outputting in gray image mode can improve detection resolution. At the same time, when the environment does not meet the requirements, outputting point cloud data can avoid outputting invalid detection information when the environment does not meet the requirements, further improving detection accuracy.

### BRIEF DESCRIPTION OF DRAWINGS

The figures are incorporated into the specification and form part of this specification, illustrating embodiments consistent with the present disclosure and used in conjunction with the specification to explain the present disclosure. It is evident that the figures described below are merely some embodiments of the present disclosure.

FIG. 1 shows a schematic diagram of the structure of a LiDAR, according to some embodiments;

FIG. 2 shows a schematic diagram of an array-type single-photon avalanche diode (SPAD array), according to some embodiments;

FIG. 3 shows an exemplary flowchart corresponding to a detection method, according to some embodiments;

FIG. 4 shows an exemplary flowchart corresponding to another detection method, according to some embodiments;

FIG. 5 shows a schematic diagram of the structure of a detection device, according to some embodiments; and

FIG. 6 shows a schematic diagram of the structure of an electronic device, according to some embodiments.

### DETAILED DESCRIPTION

When referring to the accompanying drawings in the following description, unless otherwise indicated, the same numbers in different drawings represent the same or similar elements. The embodiments described in the following exemplary examples of devices and methods that are consistent with some aspects of the present disclosure as detailed in the attached claims.

The above drawings are merely illustrative of the processing included in the method of the exemplary embodiments disclosed herein. The processing shown in the drawings does not indicate or restrict the timing sequence of these processes. These processes can be executed synchronously or asynchronously, for example, in multiple modules.

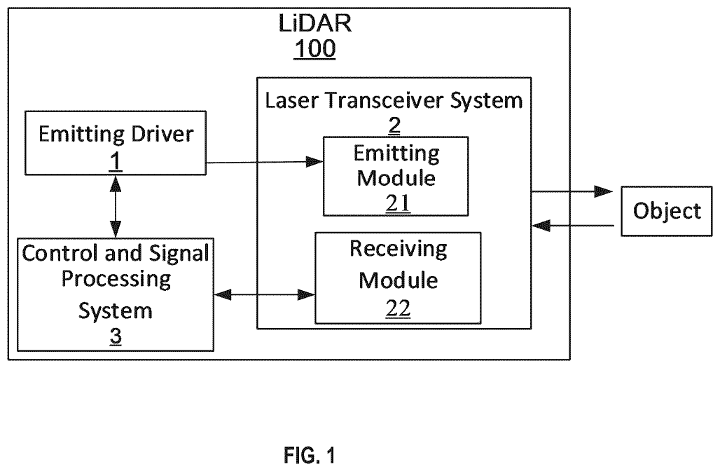

FIG. 1 shows a schematic diagram of the structure of a LiDAR, according to some embodiments.

As shown in FIG. 1, FIG. 1 illustrates a LIDAR 100 based on time-of-flight measurement for distance measurement, which includes an emitting driver 1, a laser transceiver system 2, and a control and signal processing system 3. The laser transceiver system 2 includes an emitting module 21 and a receiving module 22. Measurement information of the detection target is obtained by emitting pulse signals and receiving echo pulse signals reflected back from objects. Since most LiDAR systems currently use avalanche photodiodes (APDs) or silicon photomultipliers (SiPMs) as the receiving detectors, the resolution is usually small, making it unable to recognize semantic information. Additionally, if the emitted light is blocked, the object cannot be detected.

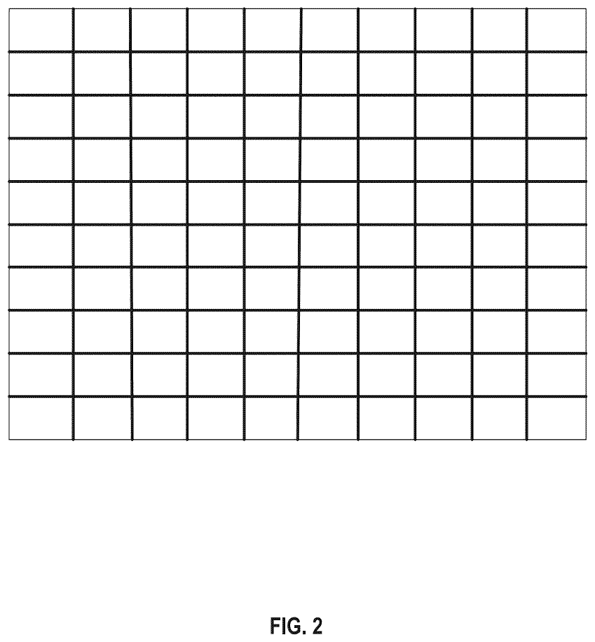

FIG. 2 shows a schematic diagram of the SPAD array, according to some embodiments.

The present disclosure provides a detection method, as shown in FIG. 2, which can achieve pixel-level resolution and high-precision distance information through an array-type single-photon avalanche diode (SPAD). A number of SPADs included in the array-type receiver or the arrangement of SPADs can be adjusted. The signal reception method for the array-type receiver could be adjusted. For example, the signal reception method for the array-type receiver can be one-dimensional addressable reception (one scan corresponds to the reception of entire rows or columns of SPADs) or two-dimensional addressable reception (one scan corresponds to a block or a predetermined number of SPADs reception). For example, the transmitter corresponding to the array-type receiver can be an edge emitter, such as a laser diode (LD), or it can also be a vertical cavity surface emitting laser (VCSEL). This application does not limit the scanning method for the transmitter. In an embodiment, the emission can be achieved by line array scanning devices, or it can also be achieved by two-dimensional driving scanning for emission scanning, or by addressable driving scanning for emission scanning. In an embodiment, implement scanning through a scanning device added to the transmitter, where the scanning device can be a MEMS mirror, one-dimensional mirror, rotating reflector, or rotating polygon mirror. In an embodiment, a rotating platform is provided, with the transceiver system set on the rotating platform, achieving a 360-degree scan by driving the rotating platform to rotate.

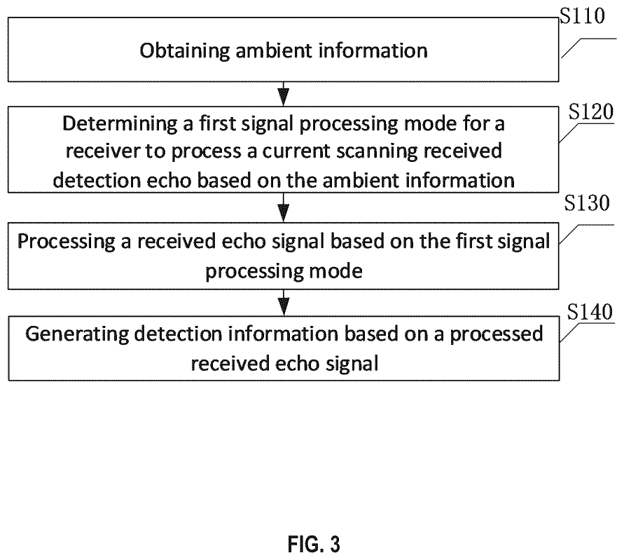

FIG. 3 shows an exemplary flowchart corresponding to a detection method, according to some embodiments.

The following is an embodiment of the detection method provided herein. As shown in FIG. 3, the method includes the following steps:

Step S110: Obtaining ambient information.

In some embodiments, the ambient information includes ambient light, ambient temperature, ambient humidity, or a combination of one or more of them.

Step S120: Determining a first signal processing mode for a receiver to process a current scanning received detection echo based on the ambient information.

The first signal processing mode can be a gray image output mode or a point cloud signal processing output mode.

The ambient information includes ambient light information. Accordingly, determining the first signal processing mode for the receiver to process the current received detection echo based on the ambient information includes: determining the first signal processing mode for the receiver to process the current received detection echo based on the ambient light information.

Determining the first signal processing mode for the receiver to process the current received detection echo based on the ambient light information includes: determining that the receiver performs detection echo output in the gray image output mode when the value of ambient light intensity information is greater than a first preset value; and determining that the receiver performs detection echo output in the point cloud signal processing mode when the value of the ambient light intensity information is less than or equal to the first preset value.

The ambient information may include ambient temperature information. Accordingly, determining a first signal processing mode for a receiver to process a current scanning received detection echo based on the ambient information includes determining the first signal processing mode for the receiver to process the current received detection echo based on the ambient temperature information.

The ambient information may be ambient temperature information. Determining the first signal processing mode for the receiver to process the current received detection echo includes: when the value of the ambient temperature is greater than a second preset value, determining that the receiver performs detection echo output in the gray image output mode; and when the value of the ambient temperature information is less than or equal to the second preset value, determining that the receiver performs detection echo output in the point cloud signal processing mode.

The ambient information may include ambient humidity information. Accordingly, determining the first signal processing mode for the receiver to process the current received detection echo based on the ambient information includes determining the first signal processing mode for the receiver to process the current received detection echo based on the ambient humidity information.

The ambient information may include ambient humidity information. Based on the ambient information to determine the first signal processing mode for the receiver to process the current received detection echo includes: determining whether the ambient humidity is greater than a third threshold value; when the ambient humidity is greater than the third threshold value, determining that the receiver outputs the detection echo in the gray image processing mode; determining whether the ambient humidity is less than or equal to the third threshold value; and when the ambient humidity is less than or equal to the third threshold value, determining that the receiver outputs the detection echo in the point cloud signal processing mode.

The ambient information may include ambient light and ambient temperature; or the ambient information may include ambient light and ambient humidity; or the ambient information may include ambient humidity and ambient temperature. In some embodiments, determining a first signal processing mode for the receiver to process the current received detection echo based on the ambient information includes: obtaining the influence weight of each type of ambient information, and determining the first signal processing mode based on the ambient information with the highest influence weight.

Step S130: Processing a received echo signal based on the first signal processing mode.

When the first signal processing mode is the point cloud signal processing mode, processing the received echo based on the first signal processing mode includes outputting two-dimensional plane intensity information and distance information based on the received echo signal.

When the first signal processing mode is the gray image output mode, processing the received echo based on the first signal processing mode includes outputting intensity information of a two-dimensional plane based on the received echo signal, namely the gray image information. In this mode, the emitting module does not need to emit light, and only external ambient light is required to obtain detection information about the environment.

In some embodiments, before processing the received echo signal based on the first signal processing mode, the method further includes: determining the minimum receiving unit corresponding to the first signal processing mode and outputting detection information based on the minimum receiving unit.

In an embodiment, when the first signal processing mode is the point cloud signal processing mode, the output mode of the LiDAR point cloud signal processing mode typically outputs to 2*2, 3*3, or 4*4, etc., n*n SPADs. The output mode of the point cloud signal processing mode and the number of SPADs corresponding to each point depend on the detection accuracy requirements of the LiDAR system.

In an embodiment, when the first signal processing mode is the gray image mode, output can be performed according to the smallest SPAD mode (the smaller the SPAD can achieve, the smaller the output), thereby further improving the resolution. The resolution is similar to that of a low-resolution in-vehicle camera. Since the emitting module does not work, some crosstalk is reduced, such as high reflection expansion, and so on. The resolution of the gray image mode depends on the process requirements of the SPAD device.

Step S140: Generating detection information based on a processed received echo signal.

In an embodiment, one scanning includes multiple signal emission angles, and the point cloud signal processing mode includes: superimposing echo signals of each emission angle in the multiple signal emission angles; and obtaining a superimposed echo signal.

The method further includes obtaining the correspondence between the output frequency of the detection information and the scanning number. When the first preset scanning number corresponds to one output of the detection information, the detection information obtained based on the first preset scanning number is fused according to a preset rule before outputting the detection information.

The preset rule can be setting the output frequency of point cloud data and grayscale image data based on the number of preset times. For example, the point cloud images of the preset times can be fused before being fused with grayscale images. In an embodiment, in the point cloud data of the preset times, the most recent timestamp point cloud image can be fused with grayscale images for output, while other point cloud data is fused for output. In an embodiment, the preset rule can be to first output the point cloud data and grayscale image data of the preset times, and then output the fusion data of a frame of point cloud data and grayscale images. The point cloud data can be fused before being fused with grayscale image data. Any frame of point cloud data can also be fused with grayscale image data. In an embodiment, it can be the output after fusing the most recent timestamp frame of point cloud data with grayscale image data.

The first preset number can be set according to the detection accuracy requirements of the LiDAR. For example, it can be a frame of point cloud, then a frame of grayscale image, and then the two modes are fused through backend algorithms, followed by another frame of point cloud, a frame of grayscale image, repeating the operation.

In some embodiments, adjustments of the preset times can also be made based on the environment. For example, if the lighting conditions are insufficient, the frame rate of the point cloud can be increased and the frame rate of the grayscale image can be decreased, such as 2 frames of point cloud and 1 frame of grayscale, or 3 frames of point cloud and 1 frame of grayscale, meaning that the frame rate of the point cloud is greater than that of the grayscale image; and if under adverse weather conditions like rain or fog, the frame rate of the grayscale image can be increased and the frame rate of the point cloud can be decreased, such as 2 frames of grayscale and 1 frame of point cloud, or 3 frames of grayscale and 1 frame of point cloud, namely, the frame rate of the grayscale image being greater than that of the point cloud.

In the process of fusing grayscale images and point clouds, the method further includes obtaining the minimum receiving unit corresponding to the point cloud data signal processing output mode and fusing point cloud data with grayscale images based on the minimum receiving unit corresponding to the point cloud data processing mode. For example, if one point in the point cloud output mode corresponds to n*n SPADs, then n*n pixels in the image are supplemented with distance information.

In an embodiment, the method further includes, before obtaining ambient information, obtaining the sampling frequency of the detection echo signal processing mode and the sampling number of the detection echo; based on the sampling frequency of the detection echo signal processing mode and the sampling number of the detection echo, determining the signal processing mode for the current scanning received detection echo. Subsequently, based on the ambient information, a modification is made to the signal processing mode of the received detection echo for the current scanning. Specifically, as an optional implementation, if it is determined that the processing mode of this detection echo is a point cloud signal processing output mode based on the sampling frequency of the detection echo signal processing mode and the sampling number of the detection echo, and the current ambient information indicates a high-temperature environment and/or high humidity environment, then the signal processing mode is modified to a gray image output mode. Specifically, in another embodiment, if it is confirmed that the signal processing mode of the detection echo here is a gray image output mode based on the sampling frequency of the detection echo signal processing mode and the sampling number of the detection echo, and the current ambient information indicates weak light or ambient light intensity greater than a preset value (i.e., in strong light conditions), then the signal processing mode is modified to a point cloud signal processing output mode.

In an embodiment, an array-type Single Photon Avalanche Diode (SPAD) is utilized to obtain pixel-level resolution and high-precision distance information. By judging the ambient information, the first signal processing mode for a receiver to process the current received detection echo is determined based on the ambient information, the received echo signal is processed according to the first signal processing mode, and detection information is generated based on the processed received echo signal. Processing the received echo signal based on the ambient information and selecting the appropriate output mode for the received echo to output detection information, thereby overcoming the limitations of environmental factors and outputting more accurate detection information. At the same time, under conditions where the environment meets the requirements, switching the output mode of the detection echo signal can obtain higher resolution detection information. Furthermore, by fusing detection information via two signal processing modes, image information with depth information can be obtained, enabling the recognition of semantic information and further improving the accuracy of detection.

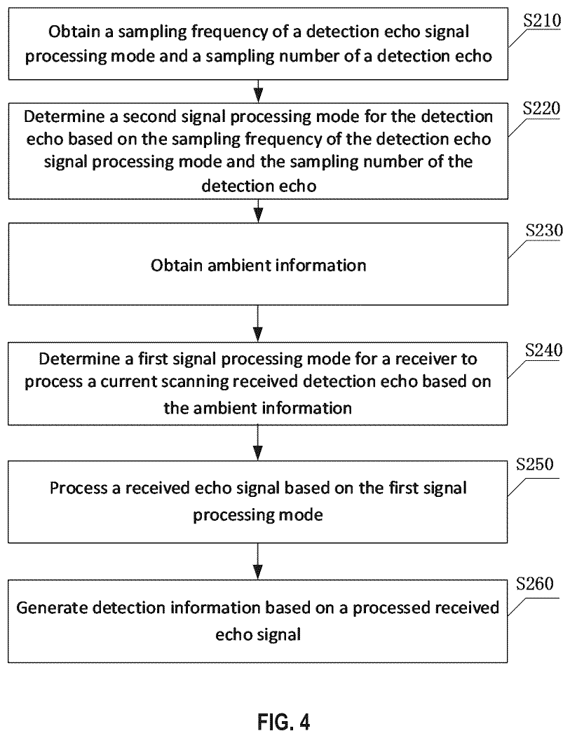

FIG. 4 shows an exemplary flowchart corresponding to another detection method, according to some embodiments.

The following is an embodiment of the detection method provided herein. As shown in FIG. 4, an implementation of the detection method provided in the present disclosure includes the following steps:

Step S210: Obtain a sampling frequency of a detection echo signal processing mode and a sampling number of a detection echo. In an embodiment, the detection echo signal processing mode includes a gray image output mode and a point cloud signal processing output mode.

The sampling frequency of a detection echo signal processing mode and the sampling number of the detection echo can be obtained. For example, obtaining the sampling frequency of a detection echo signal processing mode is to obtain the output frequency of the point cloud signal processing mode or the output frequency of the grayscale image. Obtaining the sampling number of a detection echo is to obtain the sampling number of the point cloud signal processing mode or the sampling number of the grayscale image mode. The sampling number of the point cloud signal processing mode can be the sampling number within a preset time range. In an embodiment, the sampling number of the point cloud signal processing mode can be the sampling number within a preset scanning period. In an embodiment, the sampling number of the grayscale image output mode can be the sampling number within a preset time range. In an embodiment, the sampling number of the grayscale image output mode can be the sampling number within a preset scanning period.

Step S220: Determine a second signal processing mode for the detection echo based on the sampling frequency of the detection echo signal processing mode and the sampling number of the detection echo.

In some embodiments, the second signal processing mode includes a gray image output mode or a point cloud signal processing output mode.

In some embodiments, determining the processing mode of the detection echo signal is performed based on either the sampling frequency of the detection echo signal processing mode or the sampling number of the detection echo.

For example, the sampling frequency for obtaining the gray image processing mode is to output 1 frame of gray image data for every 3 frames of collected detection echo data. Then, based on this frequency, the scanning can be grouped to obtain the number of times this detection is in the scan group. According to this number, the corresponding signal processing mode for the current scan can be obtained.

In an embodiment, when obtaining 10 times of gray image acquisition and 20 times of point cloud signal processing mode acquisition within a preset time, it is possible to continuously collect output information of a certain signal processing mode within the preset time. In an embodiment, it is possible to partially continuously output information of two signal processing modes. In an embodiment, the signal output mode can be automatically generated based on the multiple relationships of the acquisition times. For example, acquiring the point cloud signal processing mode twice and the gray image once. Consequently, the number of detections corresponding to the current scan is obtained to determine the signal processing mode for processing the current scan's detection echo.

Step S230: Obtain ambient information.

The ambient information may include ambient light, ambient temperature, ambient humidity, or a combination of one or more of them.

Step S240: Determine a first signal processing mode for a receiver to process a current scanning received detection echo based on the ambient information.

The first signal processing mode includes a gray image output mode or a point cloud signal processing output mode.

The ambient information includes ambient light information. Accordingly, determining the first signal processing mode for the receiver to process the current received detection echo based on the ambient information includes: determining the first signal processing mode for the receiver to process the current received detection echo based on the ambient light information.

Based on the ambient light information, determining the first signal processing mode for the receiver to process the current received detection echo includes: determining that the receiver performs detection echo output in the gray image output mode when the value of ambient light intensity information is greater than a first preset value; and determining that the receiver performs detection echo output in the point cloud signal processing mode when the value of the ambient light intensity information is less than or equal to the first preset value.

The ambient information may include ambient temperature information. Accordingly, determining a first signal processing mode for a receiver to process a current scanning received detection echo based on the ambient information includes determining the first signal processing mode for the receiver to process the current received detection echo based on the ambient temperature information.

The ambient information may include ambient temperature information. Determining the first signal processing mode for the receiver to process the current received detection echo includes: when the value of the ambient temperature is greater than a second preset value, determining that the receiver performs detection echo output in the gray image output mode; and when the value of the ambient temperature information is less than or equal to the second preset value, determining that the receiver performs detection echo output in the point cloud signal processing mode.

The ambient information may include ambient humidity information. Accordingly, determining the first signal processing mode for the receiver to process the current received detection echo based on the ambient information includes determining the first signal processing mode for the receiver to process the current received detection echo based on the ambient humidity information.

The ambient information may include ambient humidity information. Determining the first signal processing mode for the receiver to process the current received detection echo based on the ambient information includes: determining whether the ambient humidity is greater than a third threshold value; when the ambient humidity is greater than the third threshold value, determining that the receiver outputs the detection echo in the gray image processing mode, determining whether the ambient humidity is less than or equal to the third threshold value; and when the ambient humidity is less than or equal to the third threshold value, determining that the receiver outputs the detection echo in the point cloud signal processing mode.

The ambient information may include ambient light and ambient temperature; or the ambient information may include ambient light and ambient humidity; or the ambient information may include ambient humidity and ambient temperature. Wherein, determining the first signal processing mode for the receiver to process the current received detection echo based on the ambient information includes: obtaining the influence weight of each type of ambient information, and determining the first signal processing mode based on the highest influence weight of the ambient factor.

Step 250: Process a received echo signal based on the first signal processing mode;

When the first signal processing mode is the point cloud signal processing mode, processing the received echo based on the first signal processing mode includes outputting two-dimensional plane intensity information and distance information based on the received echo signal.

When the first signal processing mode is a gray image output mode, processing the received echo based on the first signal processing mode includes outputting intensity information of a two-dimensional plane based on the received echo signal, namely the gray image information. In this mode, the emitting module does not need to emit light, only external ambient light is required to obtain detection information about the environment.

Step 260: Generate detection information based on a processed received echo signal.

In an embodiment, one scanning includes multiple signal emission angles, and the point cloud signal processing mode includes: superimposing echo signals of each emission angle in the multiple signal emission angles; and obtaining a superimposed echo signal.

The method further includes obtaining the correspondence between the output frequency of the detection information and the scanning number. When the first preset scanning number corresponds to one output of the detection information, the detection information obtained based on the first preset scanning number is fused according to a preset rule before outputting the detection information.

The preset rule can be set according to the output frequency of point cloud data and grayscale image data in the number of preset times. For example, the point cloud images of the preset times can be fused before being fused with grayscale images. In an embodiment, in the point cloud data of the preset times, the most recent timestamp point cloud image can be fused with grayscale images for output, while other point cloud data is fused for output. In an embodiment, the preset rule can be to first output the point cloud data and grayscale image data of the preset times, and then output the fusion data of a frame of point cloud data and grayscale images. The point cloud data can be fused before being fused with grayscale image data. Any frame of point cloud data can also be fused with grayscale image data. In an embodiment, it can be the output after fusing the most recent timestamp frame of point cloud data with grayscale image data.

In an embodiment, the first preset number can be set according to the detection accuracy requirements of the LiDAR. For example, it can be a frame of point cloud, then a frame of grayscale image, and then the two modes are fused through backend algorithms, followed by another frame of point cloud, a frame of grayscale image, repeating the operation.

In some embodiments, adjustments of the preset times can be made based on the environment. For example, if the lighting conditions are insufficient, the frame rate of the point cloud can be increased and the frame rate of the grayscale image can be decreased, such as 2 frames of point cloud and 1 frame of grayscale, or 3 frames of point cloud and 1 frame of grayscale, meaning that the frame rate of the point cloud is greater than that of the grayscale image; and if in adverse weather conditions such as rain or fog, the frame rate of the grayscale image can be increased and the frame rate of the point cloud can be decreased, such as 2 frames of grayscale and 1 frame of point cloud, or 3 frames of grayscale and 1 frame of point cloud, meaning that the frame rate of the grayscale image is greater than that of the point cloud.

In the process of fusing grayscale images and point clouds, the method further includes obtaining the minimum receiving unit corresponding to the point cloud data signal processing output mode and fusing point cloud data with grayscale images based on the minimum receiving unit corresponding to the point cloud data processing mode. For example, if one point in the point cloud output mode corresponds to n*n SPADs, then n*n pixels in the image are supplemented with distance information.

Embodiments of this application utilize an array-type SPAD to obtain pixel-level resolution and high-precision distance information. By using a predetermined signal processing mode, the receiver determines the signal processing mode for the current received detection echo, and then adjusts the signal processing mode of the received detection echo based on environmental information to obtain a signal processing mode that better fits environmental factors and detection requirements. The received echo signal is processed according to the adjusted signal processing mode, and detection information is generated based on the processed received echo signal. By selecting the appropriate output mode for the received echo based on LiDAR system settings and real-time environmental information, the detection information output overcomes environmental limitations and provides more accurate detection information. Additionally, under suitable environmental conditions, switching the output mode of the detection echo signal results in higher resolution detection information. By fusing detection information from two signal processing modes, image information with depth information can be obtained, enabling semantic information recognition and enhancing detection accuracy.

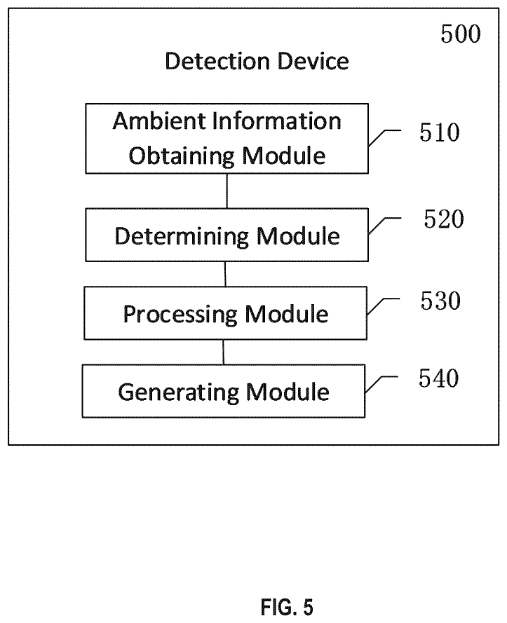

FIG. 5 shows a schematic diagram of the structure of a detection device, according to some embodiments.

Refer to FIG. 5, the detection device shown in the figure can be implemented as part or all of a terminal through software, hardware, or a combination of both, and can also be integrated as an independent module in a terminal or on a server.

The detection device 500 in the present embodiment, the above-mentioned reflectance calculation device 500 includes: an ambient information obtaining module 510 used to obtain ambient information; determining module 520 used to determine, based on the ambient information, a first signal processing mode for a receiver to process a current scanning received detection echo; processing module 530 used to process the received echo signal based on the first signal processing mode; and generating module 540 used to generate detection information based on the processed received echo signal.

In an embodiment, the obtaining module 510 is used to obtain the sampling frequency of the detection echo signal processing mode and the sampling number of the detection echo.

In an embodiment, the determining module 520 is further used to determine a second signal processing mode for the detection echo based on the sampling frequency of the detection echo signal processing mode and the sampling number of the detection echo.

In an embodiment, the ambient information includes ambient light information.

The determining module 520 is used to determine the first signal processing mode for the receiver to process the current received detection echo based on the ambient light information.

In an embodiment, the first signal processing mode is a gray image output mode or a point cloud signal processing output mode.

In an embodiment, the second signal processing mode is a gray image output mode or a point cloud signal processing output mode.

In an embodiment, the determining module 520 is used to determine that the receiver performs detection echo output in the gray image output mode when the value of ambient light intensity information is greater than a first preset value; and to determine that the receiver performs detection echo output in the point cloud signal processing mode when the value of the ambient light intensity information is less than or equal to the first preset value.

In an embodiment, the obtaining module 510 is used to obtain the minimum receiving unit corresponding to the first signal processing mode; and to output detection information based on the minimum receiving unit.

In an embodiment, the obtaining module 510 is further used to obtain a correspondence between the output frequency of the detection information and the scanning number; when the detection information is output once for a first preset scanning number, the detection information obtained based on the first preset scanning number is fused according to a preset rule before outputting the detection information.

In an embodiment, one scanning includes multiple signal emission angles, and the point cloud signal processing mode includes: superimposing echo signals of each emission angle in the multiple signal emission angles; and obtaining a superimposed echo signal.

In some embodiments, the detection device provided only exemplifies the division of various functional modules when performing the detection method. The functions can be allocated to different functional modules, dividing the internal structure of the device into different functional modules to complete some or all of the functions described above. For details not disclosed in the device embodiment of this disclosure, please refer to the implementation examples of the detection method disclosed in this disclosure, which will not be reiterated here.

The present disclosure further provides a non-transitory computer-readable storage medium on which a computer program is stored. When the program is executed by a processor, the steps of any of the methods according to the preceding embodiments are implemented. The non-transitory computer-readable storage medium may include but is not limited to any type of disk, including floppy disks, optical discs, DVDs, CD-ROMs, microdrives, and magneto-optical disks, ROM, RAM, EPROM, EEPROM, DRAM, VRAM, flash memory devices, magnetic or optical cards, nanosystems (including molecular memory ICs), or any type of medium or device suitable for storing instructions and/or data.

The present disclosure provides an electronic device, which includes a memory, a processor, and a computer program stored in the memory and executable on the processor, where the processor implements the steps of any one of the embodiments when executing the program.

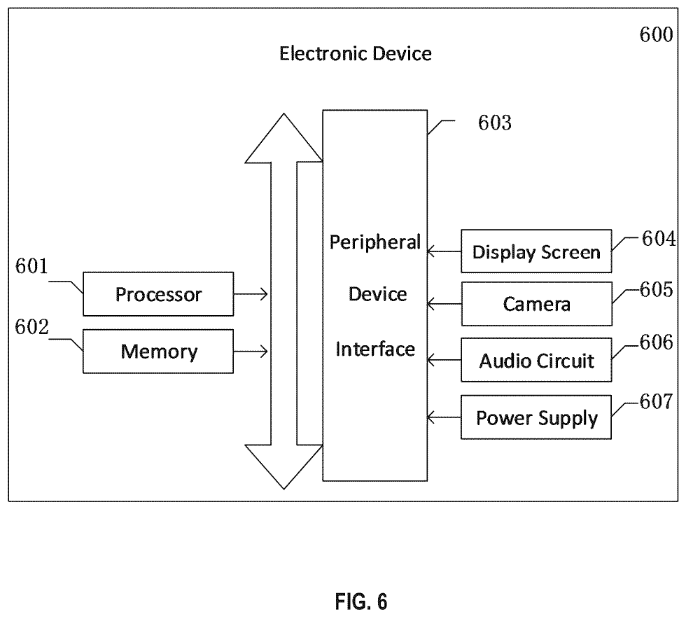

FIG. 6 shows a schematic diagram of the structure of an electronic device, according to some embodiments.

Referring to FIG. 6, the electronic device 600 includes: a processor 601 and a memory 602.

In the embodiments disclosed herein, processor 601 serves as the control center of the computer system, which can be the processor of a physical machine or a virtual machine. Processor 601 may include one or more processing cores, such as a 4-core processor, 8-core processor, etc. Processor 601 can be implemented in at least one hardware form of DSP (Digital Signal Processing), FPGA (Field-Programmable Gate Array), or PLA (Programmable Logic Array). Processor 601 may also include a main processor and a coprocessor, where the main processor is a processor used to process data in the awake state, also known as CPU (Central Processing Unit); and the coprocessor is a low-power processor used to process data in the standby state.

In the embodiments disclosed herein, the processor 601 mentioned above is specifically used for: obtaining ambient information; determining a first signal processing mode for the receiver to process the current scanning received detection echo based on the ambient information; processing the received echo signal based on the first signal processing mode; and generating detection information based on the processed received echo signal.

Furthermore, the processor 601 mentioned above is used for: obtaining the sampling frequency of the detection echo signal processing mode and the sampling number of the detection echo; based on the sampling frequency of the detection echo signal processing mode and the sampling number of the detection echo, determining the second signal processing mode for the detection echo.

Furthermore, the processor 601 is used to determine the first signal processing mode for the receiver to process the current received detection echo based on the ambient light information.

Furthermore, the first signal processing mode is a gray image output mode or a point cloud signal processing output mode. The second signal processing mode is a gray image output mode or a point cloud signal processing output mode.

Furthermore, the processor 601 is used to: when the value of the ambient light intensity information is greater than a first preset value, determine that the receiver performs detection echo output in the gray image output mode; and when the value of ambient light intensity information is less than or equal to the first preset value, it is determined that the receiver performs detection echo output in the point cloud signal processing mode.

Furthermore, the processor 601 mentioned above is used for: obtaining the minimum receiving unit corresponding to the first signal processing mode; and outputting detection information based on the minimum receiving unit.

Furthermore, the processor 601 mentioned above is used for: obtaining the correspondence between the output frequency of the detection information and the scanning number; and when the first preset scanning number corresponds to one output of the detection information, fusing the detection information obtained based on the first preset scanning number based on a preset rule, and then outputting the detection information.

Furthermore, a single scan includes multiple signal emission angles, and the point cloud signal processing mode includes: superimposing echo signals of each emission angle in the multiple signal emission angles; and obtaining a superimposed echo signal.

The memory 602 may include one or more computer-readable storage media, which can be non-transitory. The memory 602 may also include high-speed random access memory and non-volatile memory, such as one or more disk storage devices, flash storage devices. In some embodiments disclosed herein, the non-transitory computer-readable storage media in memory 602 is used to store at least one instruction that is executed by the processor 601 to implement the method disclosed herein.

In some embodiments, the electronic device 600 further includes: a peripheral device interface 603 and at least one peripheral device. The processor 601, memory 602, and peripheral device interface 603 can be interconnected via a bus or signal line. Each peripheral device can be connected to the peripheral device interface 603 via a bus, signal line, or circuit board. Specifically, the peripheral devices include at least one of a display screen 604, a camera 605, or an audio circuit 606.

The peripheral device interface 603 can be used to connect at least one peripheral device related to I/O (Input/Output) to the processor 601 and memory 602. In some embodiments disclosed herein, the processor 601, memory 602, and peripheral device interface 603 are integrated on the same chip or circuit board. In some other embodiments disclosed herein, any one or two of the processor 601, memory 602, and peripheral device interface 603 can be implemented on separate chips or circuit boards. This disclosure does not specifically limit this.

The display screen 604 is used to display the User Interface (UI). The UI can include graphics, text, icons, videos, and any combination thereof. When the display screen 604 is a touch screen, it also has the capability to capture touch signals on or above the surface of the display screen 604. These touch signals can be input as control signals to the processor 601 for processing. At this point, the display screen 604 can also be used to provide virtual buttons and/or virtual keyboards, also known as soft buttons and/or soft keyboards. In some embodiments disclosed herein, the display screen 604 can be a single one, set as the front panel of the electronic device 600. In other embodiments disclosed herein, the display screen 604 can be at least two, set on different surfaces of the electronic device 600 or designed in a foldable manner. In yet other embodiments disclosed herein, the display screen 604 can be a flexible display screen, set on a curved surface or a folding surface of the electronic device 600. Furthermore, the display screen 604 can also be set as a non-rectangular irregular shape, namely an irregular screen. The display screen 604 can be made of materials such as LCD (Liquid Crystal Display) or OLED (Organic Light-Emitting Diode).

Camera 605 is used to capture images or videos. In an embodiment, camera 605 includes a front camera and a rear camera. Typically, the front camera is set on the front panel of electronic device 600, and the rear camera is set on the back of electronic device 600. In some embodiments, there are at least two rear cameras, which can be the main camera, depth camera, wide-angle camera, telephoto camera, etc., to achieve functions such as background blur by combining the main camera and depth camera, panoramic shooting by combining the main camera and wide-angle camera, VR (Virtual Reality) shooting, or other combined shooting functions. In some embodiments disclosed herein, camera 705 may also include a flash. The flash can be a single color temperature flash or a dual color temperature flash. A dual color temperature flash refers to a combination of warm light flash and cool light flash, which can be used for light compensation under different color temperatures.

The audio circuit 606 may include a microphone and a speaker. The microphone is used to capture sound waves from the user and the environment, converting the sound waves into electrical signals input to the processor 601 for processing. For the purpose of stereo sound capture or noise reduction, there may be multiple microphones set at different parts of the electronic device 600. The microphone can also be an array microphone or an omnidirectional microphone.

The power supply 607 is used to power various components in the electronic device 600. The power supply 607 can be alternating current, direct current, disposable batteries, or rechargeable batteries. When the power supply 607 includes a rechargeable battery, the rechargeable battery can be a wired charging battery or a wireless charging battery. A wired charging battery is a battery charged through a wired connection, while a wireless charging battery is a battery charged through wireless coils. The rechargeable battery can also be used to support fast charging technology.

The structural diagram of the electronic device 600 shown in the embodiments disclosed herein does not limit the electronic device 600. The electronic device 600 may include more or fewer components than shown in the figures, combine certain components, or adopt different component arrangements.

In the description provided herein, it is important to understand that terms such as “first,” “second,” etc., are used for descriptive purposes only and do not imply any particular importance. Unless otherwise specified, “multiple” refers to two or more. The term “and/or” describing the relationship between associated objects indicates three possible relationships, for example, A and/or B can mean: only A exists, both A and B exist, or only B exists. The character “/” generally signifies an “or” relationship between the preceding and following associated objects.

What is claimed is:

1. A detection method, comprising:
obtaining ambient information;
determining a first signal processing mode for a receiver to process a current scanning received detection echo, based on the ambient information;
processing a received echo signal based on the first signal processing mode; and
generating detection information based on a processed received echo signal.

2. The detection method according to claim 1, further comprising:
obtaining a sampling frequency of a detection echo signal processing mode and a sampling number of a detection echo; and
determining a second signal processing mode for the detection echo, based on the sampling frequency of the detection echo signal processing mode and the sampling number of the detection echo.

3. The detection method according to claim 1, wherein the ambient information comprises ambient light information, and the determining the first signal processing mode for the receiver to process the current scanning received detection echo based on the ambient information comprises:
determining the first signal processing mode for the receiver to process the current received detection echo based on the ambient light information.

4. The detection method according to claim 1, wherein the first signal processing mode is a gray image output mode or a point cloud signal processing output mode.

5. The detection method according to claim 2, wherein the second signal processing mode is a gray image output mode or a point cloud signal processing output mode.

6. The detection method according to claim 4, wherein the determining the first signal processing mode for the receiver to process the current scanning received detection echo based on ambient light information comprises:
determining that the receiver performs detection echo output in the gray image output mode when a value of ambient light intensity information is greater than a first preset value; and
determining that the receiver performs detection echo output in the point cloud signal processing output mode when the value of the ambient light intensity information is less than or equal to the first preset value.

7. The detection method according to claim 1, further comprising:
obtaining a minimum receiving unit corresponding to the first signal processing mode; and
performing output of the detection information based on the minimum receiving unit.

8. The detection method according to claim 1, further comprising:
obtaining a correspondence between an output frequency of the detection information and a scanning number; and
when a first preset scanning number corresponds to one output of the detection information, after fusing the detection information obtained based on the first preset scanning number based on a preset rule, performing output of the detection information.

9. The detection method according to claim 5, wherein one scanning comprises a plurality of signal emission angles, and the point cloud signal processing output mode comprises:
superimposing echo signals of each emission angle in the plurality of signal emission angles; and
obtaining a superimposed echo signal.

10. A detection apparatus, comprising:
an ambient information obtaining module, configured to obtain ambient information;
a determining module, configured to determine, based on the ambient information, a first signal processing mode for a receiver to process a current scanning received detection echo;
a processing module, configured to process a received echo signal based on the first signal processing mode; and
a generating module, configured to generate detection information based on a processed received echo signal.

11. An electronic device, comprising a memory, a processor, and a computer program stored in the memory and executable on the processor, wherein the processor implements a detection method when executing the computer program, wherein the detection method comprises:
obtaining ambient information;
determining a first signal processing mode for a receiver to process a current scanning received detection echo, based on the ambient information;
processing a received echo signal based on the first signal processing mode; and
generating detection information based on a processed received echo signal.
